(19) United States
(12) Patent Application Publication
(10) Pub. No.: US 2015/0003234 A1
(43) Pub. Date: Jan. 1, 2015

(54) METHODS AND SYSTEMS FOR CACHING CONTENT IN A NETWORK

(71) Applicant: Alcatel-Lucent USA Inc., Murray Hill, NJ (US)

(72) Inventors: Dragan SAMARDZIJA, Highlands, NJ (US); Reinaldo VALENZUELA, Holmdel, NJ (US); Gregory WRIGHT, Fair Haven, NJ (US)

(73) Assignee: ALCATEL-LUCENT USA INC., Murray Hill, NJ (US)

(21) Appl. No.: 13/928,732

(22) Filed: Jun. 27, 2013

(51) Int. Cl. H04W 28/02

(52) U.S. Cl. CPC H04W 28/0231
USPC 370/229

(57) ABSTRACT

At least one example embodiment discloses a method for caching data in a system of base stations. The method includes obtaining, by a gateway, parameters for a content provider to provide data to at least one of the base stations for caching, the gateway providing an interface between the content provider and the system of base stations, receiving data from the content provider and transmitting the received data to the at least one of the base stations for caching based on the parameters.

### BACKGROUND

Heterogeneous networks (HetNets or HTNs) are now being developed wherein cells of smaller size are embedded within the coverage area of larger macro cells and the small cells could even share the same carrier frequency with the umbrella macro cell, primarily to provide increased capacity in targeted areas of data traffic concentration. Such heterogeneous networks try to exploit the spatial distribution of users (and traffic) to efficiently increase the overall capacity of the wireless network. Those smaller-sized cells are typically referred to as pico cells or femto cells, and for purposes of the description herein will be collectively referred to as small cells. Such heterogeneous networks try to exploit the spatial variations in user (and traffic) distribution to efficiently increase the overall capacity of the wireless network.

In mobile networks, users are able to download rich-media such as video content. Currently, video content is delivered to a user upon request through mechanisms that pull in content from servers within the network. Content is pulled in near-real time when needed, even if the network is in congestion.

### SUMMARY

Example embodiments disclose methods and systems for caching content in a network.

Service providers have limited mechanisms to implement and offer higher-quality services that would entice content providers to pay for exclusive delivery of their data using those services. The current Quality of Service (QoS) mechanisms in 3G and 4G are limited in offering differentiating end-user experience.

The inventors have discovered a novel mechanism where content providers are offered additional services if their content is timely cached in base stations.

If requested content is present in a base station cache, the content is delivered much faster and with lower latency because a backhaul is not used to fetch the requested data. For the cached content, the end-user experience will be significantly better than for the content which is not already cached and needs to be transported over a backhaul first.

Considering that cache size and backhaul bandwidth allocated for caching is limited, service providers may offer services allowing them to share profit with the content providers whose content is exclusively cached, and later delivered with an added end-user experience.

At least one example embodiment discloses a method for caching data in a system of base stations. The method includes obtaining, by a gateway, parameters for a content provider to provide data to at least one of the base stations for caching, the gateway providing an interface between the content provider and the system of base stations, receiving data from the content provider and transmitting the received data to the at least one of the base stations for caching based on the parameters.

In an example embodiment, the transmitting is not based on a direct response to a request from a user.

In an example embodiment, the transmitting transmits the received data when traffic on a backhaul between the gateway and the at least one of the base stations is below a threshold.

In an example embodiment, the transmitting transmits the received data based on a time of day.

In an example embodiment, the transmitting transmits the received data based on an amount of previously transmitted data for caching.

In an example embodiment, the parameters include at least one of a minimum size of cached data dedicated to the content provider, a maximum latency for caching, a geographic region for caching, a number of the base stations to cache the received data, and a length of time the received data will be cached.

In an example embodiment, the method further includes determining a number of requests for the cached data and permitting the content provider to access the number of requests.

In an example embodiment, the method further includes adjusting the parameters based on the number of requests.

In an example embodiment, the method further includes providing information to users of the at least one of the base stations, the information indicating that the received data is cached.

In an example embodiment, the method further includes obtaining a price for content, the price being based on whether the content is the cached data.

At least one example embodiment discloses a processor for caching data in a system of base stations. The processor is configured to obtain parameters for a content provider to provide data to at least one of the base stations for caching, the processor providing an interface between the content provider and the system of base stations, receive data from the content provider, and transmit the received data to the at least one of the base stations for caching based on the parameters.

In an example embodiment, the transmitting is not based on a direct response to a request from a user.

In an example embodiment, the processor is configured to transmit the received data when traffic on a backhaul between the gateway and the at least one of the base stations is below a threshold.

In an example embodiment, the processor is configured to transmit the received data based on a time of day.

In an example embodiment, the processor is configured to transmit the received data based on an amount of previously transmitted data for caching.

In an example embodiment, the parameters include at least one of a minimum size of cached data dedicated to the content provider, a maximum latency for caching, a geographic region for caching, a number of the base stations to cache the received data, and a length of time the received data will be cached.

In an example embodiment, the processor is configured to determine a number of requests for the cached data and permit the content provider to access the number of requests.

In an example embodiment, the processor is configured to adjust the parameters based on the number of requests.

In an example embodiment, the processor is configured to provide information to users of the at least one of the base stations, the information indicating that the received data is cached. In an example embodiment, the processor is configured to obtain a price for content, the price being based on whether the content is the cached data.

At least one example embodiment discloses a processor for a service provider. The processor is configured to permit a content provider to provide data to a base station cache based on parameters set by a service provider.

### BRIEF DESCRIPTION OF THE DRAWINGS

Example embodiments will be more clearly understood from the following detailed description taken in conjunction with the accompanying drawings. FIGS. 1-3 represent non-limiting, example embodiments as described herein.

FIG. 1 illustrates a portion of a wireless communication system according to an example embodiment;

FIG. 2A illustrates a gateway according to an example embodiment;

FIG. 2B illustrates a small cell base station according to an example embodiment; and

FIG. 3 illustrates a method of caching data in a system according to an example embodiment.

### DETAILED DESCRIPTION

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like, which may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

As disclosed herein, the term “storage medium”, “storage unit” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “user equipment” or “UE” may be synonymous to a user equipment, mobile station, mobile user, access terminal, mobile terminal, user, subscriber, wireless terminal, terminal and/or remote station and may describe a remote user of wireless resources in a wireless communication network. Accordingly, a UE may be a wireless phone, wireless equipped laptop, wireless equipped appliance, etc.

The term “base station” may be understood as a one or more cell sites, base stations, nodeBs, enhanced NodeBs, access points, and/or any terminus of radio frequency communication. Although current network architectures may consider a distinction between mobile/user devices and access points/cell sites, the example embodiments described hereafter may also generally be applicable to architectures where that distinction is not so clear, such as ad hoc and/or mesh network architectures, for example.

Communication from the base station to the UE is typically called downlink or forward link communication. Communication from the UE to the base station is typically called uplink or reverse link communication.

Backhaul represents a bottleneck for deploying multi-carrier 3G and 4G base stations, and small/metro cells, in particular. Due to the current QoS mechanisms which offer very limited differentiation in end-user experience, content providers are not interested to pay more for exclusivity, i.e., higher-priority for their content delivery. Typically, all content on the web is treated equally when transported over wireless access networks.

Conventionally, content providers have no choice but to use services broadly available to everyone else, lacking any differentiation in their content delivery speed and latency. On the other hand, service providers lack truly distinguishing services enabling them to share profit with content providers willing to pay for exclusive delivery of their content.

The inventors have discovered a novel mechanism where content providers are offered additional services if their content is timely cached in base stations. If requested content is present in a base station cache, the content is delivered much faster and with lower latency because a backhaul is not used to fetch the requested data. For the cached content, the end-user experience will be significantly better than for the content which is not already cached and needs to be transported over the backhaul first.

Considering that cache size and backhaul bandwidth allocated for caching is limited, service providers offer services allowing them to share profit with the content providers whose content is exclusively cached, and later delivered with an added end-user experience.

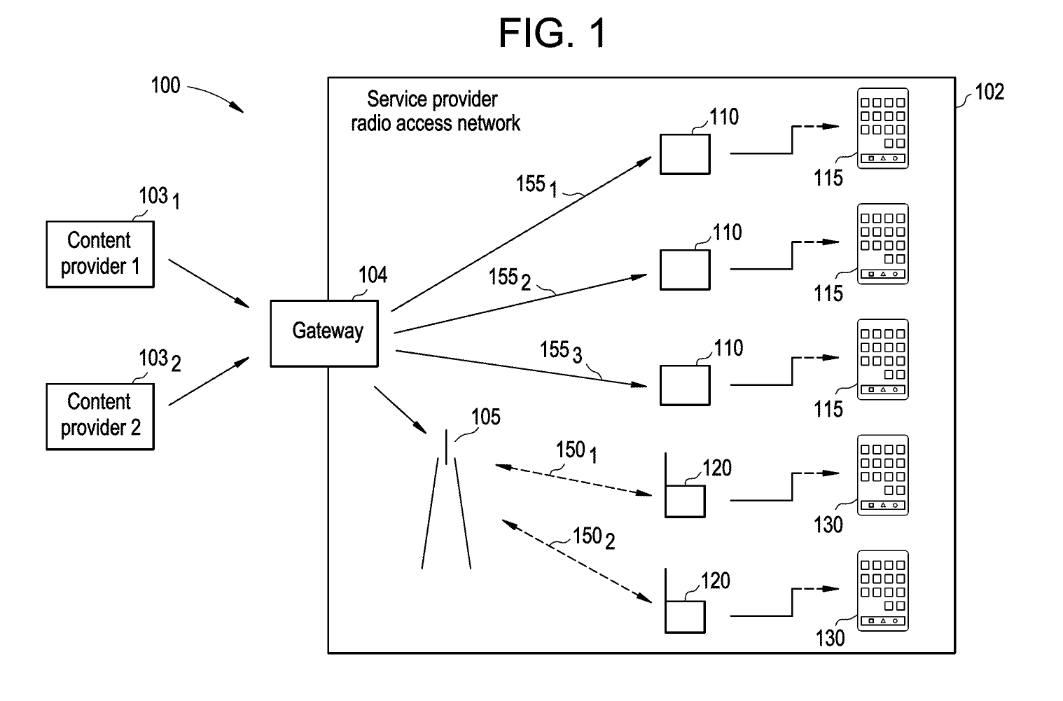

FIG. 1 illustrates a system according to an example embodiment. A system 100 includes a service provider network 102 and content providers 103₁-103₂. A service provider offers services, such as data transport services or content distribution to other service providers. This includes providing a transport network, access to residential subscribers in an area, content servers, caching devices, billing systems and authentication systems.

The content providers 103₁-103₂ may be any entities that have multimedia content to offer. Examples of the content providers 103₁-103₂ include television broadcast networks, movie providers and advertisers. The multimedia content provided by the content providers 103₁-103₂ may include programming content and advertising content. Programming content may include, for example, TV shows, movies, music videos, etc.

The service provider network 102 may be a HetNet LTE network, but is not limited thereto. The service provider network 102 includes a content caching gateway 104. The content caching gateway 104 is an interface between the service provider network 102 and the content providers 103₁-103₂.

In one example, the content caching gateway 104 may be a gateway or other computer device including one or more Central Processing Units (CPUs), digital signal processors (DSPs), application-specific-integrated-circuits, field programmable gate arrays (FPGAs) computers or the like configured to implement the functions and/or acts discussed herein. These terms in general may be referred to as processors.

The service provider network 102 includes a backhaul hub or macro cell base station 105. The service provider network 102 may include a macro cell served by the macro base station 105. Macro cell and macro base station may both be referred to as a macro cell or a macro. While only one macro cell is shown, the network of FIG. 1 may include more than one macro cell. Each macro cell includes a macro base station 105. The macro base station 105 is a serving base station to UEs 130.

The macro cell includes a number of small cells served by small cell base stations 120, respectively.

The content caching gateway 104 communicates with the macro base station 105 and small cell base stations 110 through S1-U interfaces, for example. The content caching gateway 104 may communicate with the small cell base stations 110 over backhaul links 155₁, 155₂ and 155₃, respectively. The small cell base stations 110 may communicate with the UEs 115 using any known method (e.g., WiFi, 3G and LTE).

Also, the small cell base stations 120 may communicate with the UEs 130 using any known method (e.g., WiFi, 3G and LTE).

In one embodiment, the macro and small cells are Long Term Evolution (LTE) macro and small cells. However, the embodiments are not limited to this radio access technology (RAT), and the macro and small cells may be of different RATS. Furthermore, the macro base station 105 may communicate with the small cell base stations 120 over backhaul links 150₁ and 150₂, respectively, as shown in FIG. 1. The backhaul links 150₁ and 150₂ may be non-line-of-sight (NLOS) wireless backhauls, line-of-sight (LOS) wireless or any other wireline backhaul technology implementing the LTE X2 interface, for example. The UEs 115 and 130 may be present in the macro and small cells.

Each of the small cell base stations 110 and 120 includes a local cache.

In an example embodiment, the content caching gateway 104 is an interface between the content providers 103₁, 103₂ and the network of base stations 105, 110 and 120.

The service provider offers exclusive caching to the content providers. Through service-level agreements (SLA) between the service provider and the content providers 103₁, 103₂, respectively, the gateway 104 may guarantee to the content provider: minimum size of the exclusively cashed content; maximum latency for loading content into the caches; geographic region for caching; number of base stations, or expected user population covered, where the content is cached; and how long the cached content will be available in the caches of the base stations 105, 110 and 120.

In FIG. 1, the two content providers 103₁, 103₂ send content to the gateway 104 using an application-programming interface (API) and the gateway 104 will backhaul it to each base station 110 and 120, i.e., small cell, in a particular geographic region, over the backhaul links 155₁-155₃ and 150₁-150₂. The caching may be implemented over different backhaul technologies such as NLOS wireless, passive optical network (PON) or Ethernet.

For example, a latest movie trailer, in high-definition, will be sent by a content provider, and then cached in each small cell in a particular urban area.

The application-programming interface (API), between the gateway 104 and each of the content providers 103₁, 103₂, permits each content provider 103₁, 103₂ to request what content, when and where it will be cached by the gateway 104.

The gateway 104 enforces restrictions on access to the base station caches by the content provider using the API. The API may, for example, restrict the content provider's access to the base station cache to certain times of the day, ensure that loading the cache is done during low traffic intervals when the respective backhaul link is lightly used, enforce limits on cache usage, or provide a means to indicate to the service provider that a content provider had loaded more than the contracted amount of data, which would allow assessing an overage charge.

Each of the small cells 115, 130 may update and/or expand its respective cache though content pre-loading, or when a certain content is requested by a user, while the request is being served, the content is cached for potential future usage.

The requested content may be cached only once, occupying the backhaul resources just that one time, while consumed multiple times by many users over the wireless access links.

The macro cell base station 105 may use a broadcast mechanism in the backhaul when caching content in small cell base stations 120. In this way, one-time usage of the backhaul resources will convey content to be cached to multiple base stations, in particular multiple small cells in a predefined geographic area. The gain over conventional unicast backhauling increases linearly with the number of base stations receiving the same broadcast transmission.

A broadcast mechanism is also available in Ethernet (e.g., to cache content in the small cell base stations 110).

In an example embodiment, content to be cached is broadcasted by the macro cell base station 105 during a time period lasting T_{L}. During the time period lasting T_{L}, the small cell base stations 120 receive the broadcasted content and store the content in their caches. The content may be immediately available to serve end users, or available for potential future usage.

In an example embodiment, the macro cell base station 105 broadcasts a unique signal. For example, if a reuse-1 wireless backhaul network is implemented, the transmissions from neighbouring macro cell base stations will interfere, but macro cell-specific content is broadcasted.

Efficiency improvements stem from usage of a single backhaul resource to serve multiple small-cell content caching, rather than the individual unicast backhauling.

Content that is broadcasted during T_{L} may be decided by the macro cell base station 105 using many different criteria (e.g., popularity of the content or reacting to a particular end-user request).

In another example embodiment, multiple macro cell base stations broadcast the same signal simultaneously during the interval T_{L}. In this way, a single frequency network (SFN) is created. Since there is no interference, as otherwise exist in reuse-1 cases, the SINR during the SFN broadcast is significantly higher. This results in an increased coverage and/or data rates during the content caching.

Through the API, the gateway 104 monitors how frequently cached content is accessed by the UEs 115, 130, which allows crafting of billing policies based on how frequently content is accessed.

For example, content frequently accessed from the cache could be charged at a lower rate than rarely accessed cached content, since caching rarely accessed content wastes cache capacity, forcing more traffic over the backhaul link. In a dynamic fashion, the gateway 104 may adjust the amount charged to the content provider based on demand from the UEs 115, 130.

In an example embodiment, the service provider network 102 may encourage the end users to consume that cached content in addition to providing much faster content downloads (resulting from the content being cached). For example, the service provider network 102 may implement a user-terminal portal application (APP) where users explicitly know which content is available for fast downloads (news, video, trailers, movies, sitcoms, etc.) and/or, if a user uses the cached content, the use will not count towards a monthly data cap. The macro cell base station 105 and small cell base stations 110 are configured to monitor downloads and notify the gateway 104 of such downloads. Alternatively, the service provider network 102 may provide a portal-like web page which users can access via a browser (e.g., a home page). Through the APP and/or the web-portal, the users will have direct access to rich and extensive cached content. The users are enticed to use that content since the cached content is delivered by the service provider network 102 faster than non-cached content.

By caching content, less of a burden is put on the backhaul network and the exclusive content will be delivered significantly faster compared to the content that is not cached.

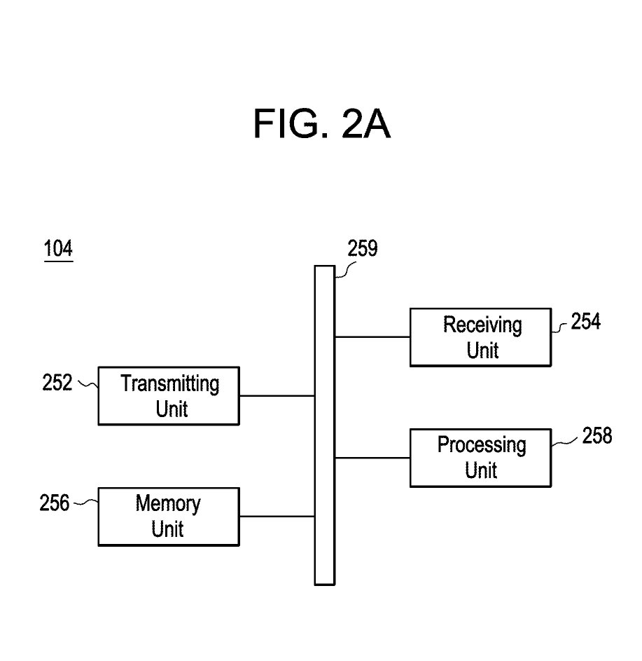

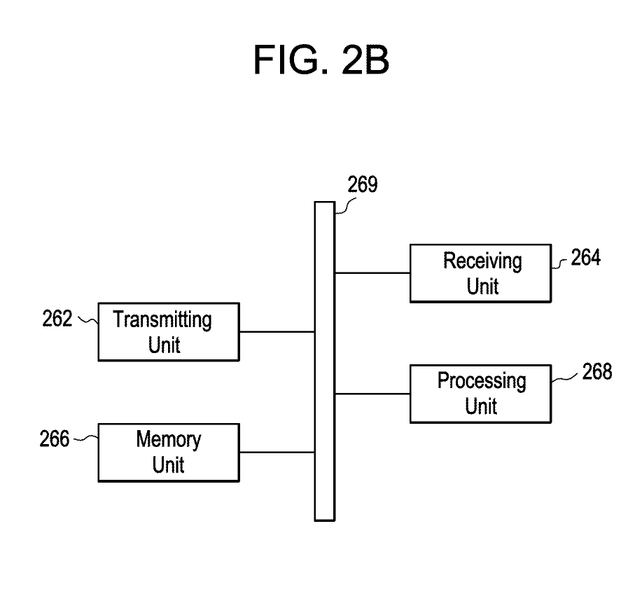

FIG. 2A illustrates the gateway 104 in more detail. Referring to FIG. 2A, the gateway 104 may include, for example, a data bus 2, a transmitting unit 252, a receiving unit 254, a memory unit 256, and a processing unit 258.

The transmitting unit 252, receiving unit 254, memory unit 256, and processing unit 258 may send data to and/or receive data from one another using the data bus 259. The transmitting unit 252 is a device that includes hardware and any necessary software for transmitting wired and/or wireless signals including, for example, data signals and control signals, via one or more wired and/or wireless connections to other network elements in the communications system 100.

The receiving unit 254 is a device that includes hardware and any necessary software for receiving wired and/or wireless signals including, for example, data signals and control signals, via one or more wired and/or wireless connections to other network elements in the communications system 100.

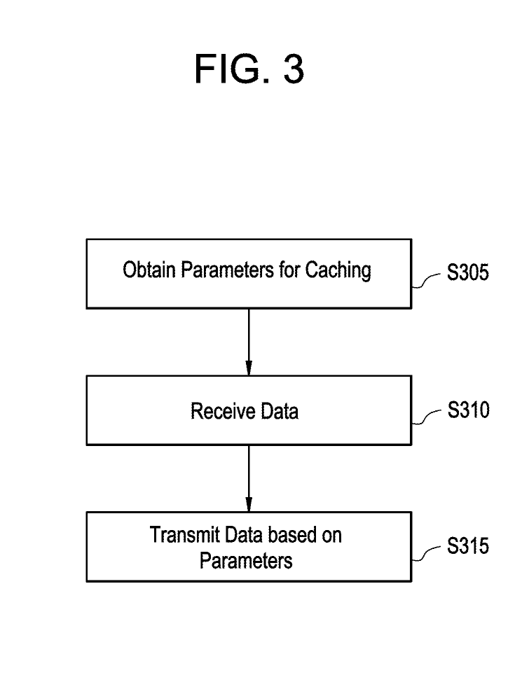

The memory unit 256 may be any device capable of storing data including magnetic storage, flash storage, etc. The memory unit 256 may store codes or programs for operations of the processing unit 258. For example, the memory unit 256 may include the instructions to execute the functions described in reference to FIGS. 1 and 3.

The memory unit 256 may include one or more memory modules. The memory modules may be separate physical memories (e.g., hard drives), separate partitions on a single physical memory and/or separate storage locations on a single partition of a single physical memory. The memory modules may store information associated with the installation of software (e.g., imaging processes).

The processing unit 258 may be any device capable of processing data including, for example, a microprocessor configured to carry out specific operations based on input data, or capable of executing instructions included in computer readable code.

For example, the processing unit 258 is configured to obtain parameters for a content provider to provide data to at least one of the base stations for caching, the processing unit 258 providing an interface between the content provider and the system of base stations, receive data from the content provider, and transmit the received data to the at least one of the base stations for caching based on the parameters.

In an example embodiment, the transmitting is not based on a direct response to a request from a user.

The processing unit 258 is configured to transmit the received data when traffic on a backhaul between the gateway and the at least one of the base stations is below a threshold.

The processing unit 258 is configured to transmit the received data based on a time of day.

The processing unit 258 is configured to transmit the received data based on an amount of previously transmitted data for caching. The parameters include at least one of a minimum size of cached data dedicated to the content provider, a maximum latency for caching, a geographic region for caching, a number of the base stations to cache the received data, and a length of time the received data will be cached.

The processing unit 258 is configured to determine a number of requests for the cached data and permit the content provider to access the number of requests.

The processing unit 258 is configured to adjust the parameters based on the number of requests.

The processing unit 258 is configured to provide information to users of the at least one of the base stations, the information indicating that the received data is cached. The processing unit 258 is configured to obtain a price for content, the price being based on whether the content is the cached data.

The processing unit 258 is configured to permit a content provider to provide data to a base station cache based on parameters set by a service provider.

FIG. 2B illustrates an example embodiment of a small cell base station. The small cell base station shown in FIG. 2B may be the same as the small cell base stations 110, 120, shown in FIG. 1.

Referring to FIG. 2B, the small cell base station may include, for example, a data bus 269, a transmitting unit 262, a receiving unit 264, a memory unit 266, and a processing unit 268.

The transmitting unit 262, receiving unit 264, memory unit 266, and processing unit 268 may send data to and/or receive data from one another using the data bus 269. The transmitting unit 262 is a device that includes hardware and any necessary software for transmitting wireless signals including, for example, data signals, control signals, and signal strength/quality information via one or more wireless connections to other network elements in the system 100.

The receiving unit 264 is a device that includes hardware and any necessary software for receiving wireless signals including, for example, data signals, control signals, and signal strength/quality information via one or more wireless connections to other network elements in the system 100.

The memory unit 266 may be any device capable of storing data including magnetic storage, flash storage, etc. The memory unit 266 may be used as the local cache and, therefore, stores the cached content transmitted by the gateway 104.

The processing unit 268 may be any device capable of processing data including, for example, a microprocessor configured to carry out specific operations based on input data, or capable of executing instructions included in computer readable code.

FIG. 3 illustrates a method for caching content in a system of base stations, such as the system 100, shown in FIG. 1. The method shown in FIG. 3 may be performed by a content caching gateway, such as the gateway 104.

At S305, the gateway obtains parameters for a content provider to provide content to at least one of the base stations for caching. The gateway provides an API between the content provider and the system of base stations.

The parameters are may be programmed into the gateway and obtain from the SLA between the content provider and service provider. For example, the parameters include at least one of a minimum size of cached data dedicated to the content provider, a maximum latency for caching, a geographic region for caching, a number of the base stations to cache the received data, and a length of time the received data will be cached.

At S310, the gateway receives data from the content provider. The data may be the content to be cached. At S315, the gateway transmits the received data to the base stations based on the parameters obtained by the gateway. Consequently, the transmitting is not based on a direct response to a request from a user, but rather on parameters established by the SLA.

For example, the gateway may transmit the received data when traffic on a backhaul between the gateway and the at least one of the base stations is below a threshold, transmit the received data based on a time of day, and/or transmit the received data based on an amount of previously transmitted data for caching.

The gateway may also provide the content provider with data regarding the content that is cached. For example, the gateway may determine a number of requests for the cached data and permit the content provider to access the number of requests. The gateway may then adjust the parameters based on the number of requests. The gateway may also provide information to users of the at least one of the base stations indicating that the received data is cached. Thus, users are aware of content that is directly available from a base station. The gateway may also obtain a price for the content based on whether the content is the cached data.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. A method for caching data in a system of base stations, the method comprising:
obtaining, by a gateway, parameters for a content provider to provide data to at least one of the base stations for caching, the gateway providing an interface between the content provider and the system of base stations;
receiving data from the content provider; and
transmitting the received data to the at least one of the base stations for caching based on the parameters.

2. The method of claim 1, wherein the transmitting is not based on a direct response to a request from a user.

3. The method of claim 1, wherein the transmitting transmits the received data when traffic on a backhaul between the gateway and the at least one of the base stations is below a threshold.

4. The method of claim 1, wherein the transmitting transmits the received data based on a time of day.

5. The method of claim 1, wherein the transmitting transmits the received data based on an amount of previously transmitted data for caching.

6. The method of claim 1, wherein the parameters include at least one of a minimum size of cached data dedicated to the content provider, a maximum latency for caching, a geographic region for caching, a number of the base stations to cache the received data, and a length of time the received data will be cached.

7. The method of claim 1, further comprising:
determining a number of requests for the cached data; and
permitting the content provider to access the number of requests.

8. The method of claim 7, further comprising:
adjusting the parameters based on the number of requests.

9. The method of claim 1, further comprising:
providing information to users of the at least one of the base stations, the information indicating that the received data is cached.

10. The method of claim 1, further comprising:
obtaining a price for content, the price being based on whether the content is the cached data.

11. A processor for caching data in a system of base stations, the processor configured to,
obtain parameters for a content provider to provide data to at least one of the base stations for caching, the processor providing an interface between the content provider and the system of base stations,
receive data from the content provider, and
transmit the received data to the at least one of the base stations for caching based on the parameters.

12. The processor of claim 11, wherein the transmitting is not based on a direct response to a request from a user.

13. The processor of claim 11, wherein the processor is configured to transmit the received data when traffic on a backhaul between the gateway and the at least one of the base stations is below a threshold.

14. The processor of claim 11, wherein the processor is configured to transmit the received data based on a time of day.

15. The processor of claim 11, wherein the processor is configured to transmit the received data based on an amount of previously transmitted data for caching.

16. The processor of claim 11, wherein the parameters include at least one of a minimum size of cached data dedicated to the content provider, a maximum latency for caching, a geographic region for caching, a number of the base stations to cache the received data, and a length of time the received data will be cached.

17. The processor of claim 11, the processor is configured to,
determine a number of requests for the cached data, and permit the content provider to access the number of requests.

18. The processor of claim 17, the processor is configured to,
adjust the parameters based on the number of requests.

19. The processor of claim 11, the processor is configured to,
provide information to users of the at least one of the base stations, the information indicating that the received data is cached.

20. The processor of claim 11, the processor is configured to,
obtain a price for content, the price being based on whether the content is the cached data.

21. A processor for a service provider, the processor configured to,
permit a content provider to provide data to a base station cache based on parameters set by a service provider.
